(19) United States
(12) Patent Application Publication
(10) Pub. No.: US 2026/0082395 A1
(43) Pub. Date: Mar. 19, 2026

(54) MACHINE LEARNING ASSISTED PDCCH RESOURCE ALLOCATION

(71) Applicant: Telefonaktiebolaget LM Ericsson (publ), Stockholm (SE)

(72) Inventors: Hamza SOKUN, Ottawa (CA); Ahmed NOUAH, Ottawa (CA); Israfil BAHCECI, Kanata (CA)

(21) Appl. No.: 19/107,337

(22) PCT Filed: Sep. 6, 2022
(86) PCT No.: PCT/IB2022/058379

§ 371 Date: Feb. 27, 2025

(51) Int. Cl. H04W 72/232; H04W 72/1273

(52) U.S. Cl. CPC H04W 72/232; H04W 72/1273

(57) ABSTRACT

According to some embodiments, a method is performed by a network node for physical downlink control channel (PDCCH) resource allocation. The method includes obtaining a data set representing a plurality of scheduling entities (SEs). Each of the SEs is associated with a signal quality, a priority, and/or a downlink control information (DCI) size. The method further includes determining a number of control channel elements (CCEs) and power allocation for the CCEs for each of the SEs based on the signal quality, the priority, and/or the DCI size associated with each of the SEs and a total power available, a power boosting threshold, and/or a total number of CCEs available. The method further includes generating a machine learning training set for online CCE and power allocation based on the determined number of CCEs and power allocation for the CCEs for each of the SEs.

### TECHNICAL FIELD

Embodiments of the present disclosure are directed to wireless communications and, more particularly, to machine learning assisted physical downlink control channel (PDCCH) resource allocation.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

In fifth generation (5G) new radio (NR) wireless networks, physical downlink control channel (PDCCH) carries downlink control information (DCI), which is used to perform some of the important operations in the network, such as uplink scheduling grant, downlink broadcast transmission and downlink scheduling assignment. Thus, efficient use of PDCCH resources, i.e., available bandwidth and power, has a direct impact on the overall network performance.

The basic structure for PDCCH is a control channel element (CCE). The number of CCEs for a PDCCH is referred to as the aggregation level (AL). A network node may transmit PDCCH on 1, 2, 4, 8, or 16 CCE ALs. Using higher CCE ALs may increase the PDCCH coverage by using a lower coding rate. At the same time, however, using unnecessarily high CCE-ALs can result in earlier exhaustion of CCE resources and serving a lower number of user equipment (UE) per slot (i.e., reducing the PDCCH capacity).

Similar to CCE AL allocation, allocation of power over PDCCH CCEs has a critical impact on PDCCH capacity and PDCCH coverage. Using a higher amount of transmit power per CCE may increase PDCCH coverage by improving channel estimation accuracy. At the same time, however, using an unnecessarily high amount of transmit power may result in earlier exhaustion of total power resource and serving a lower number of UEs per slot. Thus, attaining the best PDCCH performance requires optimizing CCE-AL assignment and power allocation over CCEs jointly to maximize not only PDCCH capacity but also PDCCH coverage.

There currently exist certain challenges. For example, obtaining the global optimal solution for the joint optimization of CCE-AL assignment and power allocations over CCEs requires a full view of scheduling entities (SEs) in a slot in baseband. Generally speaking, such a view cannot be obtained in the user plane control design structure in baseband due to implementation complexity, so each SEs is treated one-by-one. Even with a full view of all SEs, finding the global optimal solution for such a discrete optimization problem online is a difficult task requiring high computational complexity. Thus, suboptimal approaches have been considered for CCE AL assignments and power allocations for PDCCH in both LTE and NR networks.

### SUMMARY

Based on the description above, certain challenges currently exist with physical downlink control channel (PDCCH) resource allocation. Certain aspects of the present disclosure and their embodiments may provide solutions to these or other challenges. For example, particular embodiments overcome the implementation-related challenges given above using a two-step approach. In the first step, particular embodiments employ an optimization framework. This framework maximizes the number of accommodated scheduling entities (SEs) per slot and also to minimizes the total number of control channel element (CCE) consumption, while meeting several practical constraints such as total amount of power available, total amount of CCEs available and power boosting threshold.

This problem is an instance of integer linear programming. It can be solved efficiently using traditional optimization techniques. The proposed optimization problem may then be solved offline for many different instances of estimated signal to interference plus noise ratio (SINR) values (or channel quality indicator (CQI) values), downlink control information (DCI) sizes, total available power and total CCEs available. Particular embodiments eventually result in a labelled training set.

In the second step, a machine learning technique is trained on the training set and learns the complex mapping between the inputs and outputs. Afterwards, the trained machine learning algorithm may be used for predicting CCE assignments and power allocation for PDCCH per slot. Lastly, the number of consecutive downlink/uplink hybrid automatic repeat request (HARQ) discontinuous transmission (DTX) and channel state information (CSI) DTXs are counted to determine whether there is an issue with the performance of PDCCH. For poor PDCCH performance, the training set may be updated offline. During this time period, particular embodiments may resort to baseline algorithms for CCE assignment and power allocation.

According to some embodiments, a method is performed by a network node for PDCCH resource allocation (e.g., offline learning model). The method comprises obtaining a data set representing a plurality of SEs). Each of the SEs is associated with at least one of a signal quality, a priority, and a DCI size. The method further comprises determining a number of CCEs and power allocation for the CCEs for each of the SEs of the plurality of SEs based on the at least one of the signal quality, the priority, and the DCI size associated with each of the SEs and at least one of a total power available, a power boosting threshold, and a total number of CCEs available. The method further comprises generating a machine learning training set for online CCE and power allocation based on the determined number of CCEs and power allocation for the CCEs for each of the SEs of the plurality of SEs.

In particular embodiments, determining the number of CCEs and power allocation for the CCEs for each of the SEs of the plurality of SEs is based on a plurality of signal quality, priority, and DCI size combinations associated with each of the SEs. Determining the number of CCEs and power allocation may be based on whether each SE uses a common search space or a user specific search space. Determining the number of CCEs and power allocation for the CCEs may be based on a plurality of total power available, power boosting threshold, and total number of CCEs combinations. Determining the number of CCEs and power allocation for the CCEs may comprise determining a number of CCEs and power allocation for the CCEs for each aggregation level of a plurality of CCE aggregation levels. Determining the number of CCEs and power allocation for the CCEs may comprise determining a number of CCEs and power allocation for the CCEs for each of the SEs of the plurality of SEs to maximize a number of SEs per slot and minimize total CCE consumption.

In particular embodiments, the signal quality associated with each of the SEs is based on at least one of a SINR, a CQI and a geographical position of the SE.

According to some embodiments, another method is performed by a network node for PDCCH resource allocation for a plurality of SEs in a wireless network (e.g., online application of learning model). The method comprises obtaining a machine learning training set for CCE and power allocation. The machine learning training set is determined offline based on a number of CCEs and power allocation for the CCEs for each model SE of a plurality of model SEs based on at least one of a signal quality, a priority, and a DCI size associated with each of the model SEs and at least one of a model total power available, a model power boosting threshold, and a model total number of CCEs available. The method further comprises obtaining for each of the plurality of SEs in the wireless network at least one of a signal quality, a priority, and a DCI size and obtaining at least one of a total power available, a power boosting threshold, and a total number of CCEs available for the wireless network. The method further comprises determining a number of CCEs and power allocation for the CCEs for each SE of the plurality of SEs in the wireless network based on the machine learning training set, the at least one of the signal quality, the priority, and the DCI size for each SE, and the at least one of the total power available, the power boosting threshold, and the total number of CCEs available for the wireless network.

In particular embodiments, the method further comprises transmitting a PDCCH resource allocation to an SE of the plurality of the SEs in the wireless network based on the determined number of CCEs and power allocation for the CCEs for each SE of the plurality of SEs in the wireless network.

In particular embodiments, determining the number of CCEs and power allocation for the CCEs for each of the SEs of the plurality of SEs is based on whether each SE uses a common search space or a user specific search space. Determining the number of CCEs and power allocation for the CCEs may comprise determining a number of CCEs and power allocation for the CCEs for each of the SEs of the plurality of SEs to maximize a number of SEs per slot and minimize total CCE consumption.

In particular embodiments, the signal quality associated with each of the SEs is based on at least one of a SINR, a CQI and a geographical position of the SE.

In particular embodiments, the method further comprises determining a performance of the machine learning training set is degraded and obtaining an updated machine learning training set. Determining the performance of the machine learning training set is degraded may be based on at least one of a number of hybrid automatic repeat request (HARQ) discontinuous transmissions and a number of channel state information (CSI) discontinuous transmissions.

According to some embodiments, a network node comprises processing circuitry operable to perform any of the network node methods described above.

Another computer program product comprises a non-transitory computer readable medium storing computer readable program code, the computer readable program code operable, when executed by processing circuitry to perform any of the methods performed by the network node described above.

Certain embodiments may provide one or more of the following technical advantages. For example, particular embodiments of the two-stage supervised machine learning-based CCE assignment and power allocation algorithm can be summarized as follows. Particular embodiments overcome the practical limitations of currently implemented resource allocation algorithms in baseband. An optimization framework maximizes the number of accommodated SEs per slot while minimizing the total amount of CCE resource consumption by optimizing CCE and power allocations.

The framework may include several different practical constraints. The different optimization objectives may be considered in this framework.

The formulated joint optimization problem is an integer linear program that can be solved by standard optimization techniques efficiently. The optimization problems may be solved offline without using the baseband resources. No field tests are required for generating the training data set.

Particular embodiments reduce the overhead and UE-power consumption in the network. As an improvement, particular embodiments leverage UE location information instead of estimated SINR through CSI report because it can capture the major characteristics of propagation channel and interference in the environment. Particular embodiments may eliminate a hard-coded dependency on the availability and reliability of CSI reports.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 is a graph illustrating power calculation for different CCE ALs;

FIG. 2 is a block diagram illustrating runtime input-output relation for online machine learning CCE assignment and power allocation;

FIG. 3 is a flowchart illustrating the CCE assignment and power allocation algorithm, according to particular embodiments;

FIG. 4 is a block diagram illustrating an example wireless network;

FIG. 5 illustrates an example user equipment, according to certain embodiments;

FIG. 6A is a flowchart illustrating an example method in a network node, according to certain embodiments;

FIG. 6B is a flowchart illustrating another example method in a network node, according to certain embodiments; and

FIG. 7 illustrates a schematic block diagram of a wireless device and a network node in a wireless network, according to certain embodiments.

### DETAILED DESCRIPTION

Based on the description above, certain challenges currently exist with physical downlink control channel (PDCCH) resource allocation. Certain aspects of the present disclosure and their embodiments may provide solutions to these or other challenges. For example, particular embodiments overcome the implementation-related challenges described above using a two-step approach.

In the first step, particular embodiments employ an optimization framework that maximizes the number of accommodated scheduling entities (SEs) per slot and also to minimizes the total number of control channel element (CCE) consumption, while meeting several practical constraints such as total amount of power available, total amount of CCEs available and power boosting threshold. Particular embodiments result in a labelled training set.

For the purposes of this disclosure, a scheduling entity (SE) shall be understood to refer to any transmission that can be scheduled. Examples of an SE include, but are not limited to: a new UE-specific transmission (e.g., for data and/or control information); a retransmission due to previous link failure; a broadcast message (paging, system information base (SIB), etc.); and a random access channel (RACH) transmission, such as a transmission before a UE is RRC connected when a UE tries to perform initial access to the network.

In the second step, a machine learning technique is trained on the training set and learns the complex mapping between the inputs and outputs. Afterwards, the trained machine learning algorithm may be used for predicting CCE assignments and power allocation for PDCCH per slot.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art. Although particular problems and solutions may be described using new radio (NR) terminology, it should be understood that the same solutions apply to long term evolutions (LTE) and other wireless networks as well, where applicable.

Particular embodiments include an optimization framework that jointly optimizes CCE and power allocations to maximize the total number of SEs accommodated in the system per slot while minimizing the total CCE consumptions. The set of all SEs is denoted by N={1, . . . , N}, and for a particular SE with index-s, the set of (CCE aggregation level (AL), Power)-pairs is denoted by

$${K}_{s} = \{ ( {C}_{s}^{1} , {P}_{s}^{1} ) , ( {C}_{s}^{2} , {P}_{s}^{2} ) , ( {C}_{s}^{4} , {P}_{s}^{4} ) , ( {C}_{s}^{8} , {P}_{s}^{8} ) , ( {C}_{s}^{16} , {P}_{s}^{16} ) \} , where {C}_{s}^{t}$$

is the t-th CCE-AL used for the s-th SE, and

$${P}_{s}^{t}$$

is the power required for the t-th CCE-AL that is used for the s-th SE. For example, for the SE with index-1

$${K}_{1} = \{ ( {C}_{1}^{1} , {P}_{1}^{1} ) , ( {C}_{1}^{2} , {P}_{1}^{2} ) , ( {C}_{1}^{4} , {P}_{1}^{4} ) , ( {C}_{1}^{8} , {P}_{1}^{8} ) , ( {C}_{1}^{16} , {P}_{1}^{16} ) \} ,$$

and there, for example, the

$${C}_{1}^{2}$$

is the number of CCEs required for AL-2 and the

$${P}_{1}^{2}$$

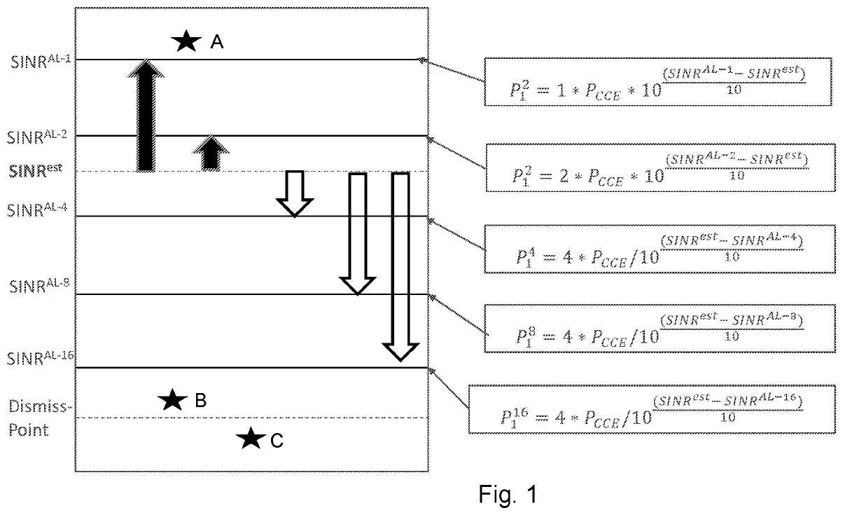

is the required minimum amount of power to use AL-2 while keeping the PDCCH block error rate (BLER) below the 1% target. More particularly, for the SE-1 with UE-specific search space (USS) illustrated in FIG. 1,

$${P}_{1}^{2} = 2 * {P}_{CCE} * 1 {0}^{\frac{( {SINR}^{AL - 2} - {SINR}^{est} )}{10}} ,$$

where P_{CCE} is the amount of power required to transmit a CCE.

FIG. 1 is a graph illustrating power calculation for different CCE ALs. For example, some SEs with AL-1 may have a high SINR value, e.g., see the star labeled A in FIG. 1, and then the power calculation is as follows:

$$( {P}_{1}^{1} = {P}_{CCE} ) , ( {P}_{1}^{2} = 1 * {P}_{CCE} * {10}^{\frac{( {SINR}^{est} - {SINR}^{AL - 1} )}{10}} ,$$

and so on.

Some SEs with AL-16 may have a low SINR value, e.g., see the star labeled B in FIG. 1, and then the power calculation is as follows:

$$( {P}_{1}^{16} = 16 {P}_{CCE} * 1 {0}^{\frac{α}{10}} ) ,$$

where α is a constant value to boost the power, e.g., 3 dB,

$$( {P}_{1}^{8} = 2 {P}^{max} ) , ( {P}_{1}^{4} = 2 {P}^{max} ) , ( {P}_{1}^{2} = 2 {P}^{max} ) , ( {P}_{1}^{1} = 2 {P}^{max} ) .$$

Note that setting

$${P}_{1}^{1}$$

to 2P^{max} means that this option is not valid.

If the signal to interference plus noise ratio (SINR) value is extremely low for a SE (below the predefined SINR threshold point, referred to as the dismissing-point), e.g., star labeled C in FIG. 1, the SE can be discarded from the list of SEs, N.

For the SE with a common search space (CSS), the set of (CCE AL, Power)-pairs is different than the one for an SE with USS. For example, for a SE with index-1,

$$\{ ( {C}_{1}^{1} , 2 {P}^{max} ) , ( {C}_{1}^{2} , 2 {P}^{max} ) , ( {C}_{1}^{4} , 2 {P}^{max} ) , ( {C}_{1}^{8} , 2 {P}^{max} ) , ( {C}_{1}^{16} , {P}_{1}^{16} ) \} .$$

The system may include particular constraints. The system constraints may include a CCE usage constraint, CCE allocation constraint, power allocation constraint, and a power boosting constraint.

For the CCE usage constraint, particular embodiments use an indicator variable yₛⁱ that represents whether the (i, s) pair, s∈N and i∈Kₛ is used for transmission. If the s-th SE uses i-th (CCE-AL, Power)-pair, then,

$${y}_{s}^{i} = 1 ; otherwise , {y}_{s}^{i} = 0 .$$

### Thus,

$${y}_{s}^{i} ∈ \{ 0 , 1 \} ,$$

N and ∀i∈Kₛ. Using this binary variable, the total number of (CCE, power)-pair for a particular SE can be shown

$${\sum }_{i ∈ {K}_{s}}^{} {y}_{s}^{i} .$$

In this system, at a given time slot, each SE is constrained to have at most one (CCE-AL, Power)-pair, and this constraint can be expressed as

$${\sum }_{i ∈ {K}_{s}}^{} {y}_{s}^{i} \leq$$

1, for all s.

For the CCE allocation constraint, in practice the total CCE usage cannot exceed the maximum number CCE budget,

$${C}_{max}^{} .$$

The total number of CCEs consumed in a slot may be expressed as

$${\sum }_{s ∈ N}^{} {\sum }_{i ∈ {K}_{s}}^{} {C}_{s}^{i} {y}_{s}^{i} .$$

Thus, the CCE budget constraint is expressed as

$${\sum }_{s ∈ N}^{} {\sum }_{i ∈ {K}_{s}}^{} {C}_{s}^{i} {y}_{s}^{i} \leq {C}_{max}^{} .$$

For the power allocation constraint, in practice the total power usage cannot exceed the maximum power budget,

$${P}_{max}^{} .$$

The total power consumed in a slot can be expressed as

$${\sum }_{s ∈ N}^{} {\sum }_{i ∈ {K}_{s}}^{} {P}_{s}^{i} {y}_{s}^{i} .$$

Thus, the power budget constraint is expressed as

$${\sum }_{s ∈ N}^{} {\sum }_{i ∈ {K}_{s}}^{} {P}_{s}^{i} {y}_{s}^{i} . \leq {P}_{max}^{} .$$

For the power boosting constraint, in practice the power boosting cannot exceed the predefined threshold,

$${P}_{BoostingThr}^{}$$

The amount of power used for boosting the SE-s can be expressed as

$${\sum }_{i ∈ {K}_{s}}^{} \vert {P}_{s}^{i} - {P}_{C C E} {C}_{s}^{i} \vert {y}_{s}^{i} .$$

Thus, the power-boosting constraint is expressed as

$${\sum }_{i ∈ {K}_{s}}^{} \vert {P}_{s}^{i} - {P}_{C C E} {C}_{s}^{i} \vert {y}_{s}^{i} \leq {P}_{BoostingThr}^{} .$$

The system design include two objectives. The first one accounts for the number of SEs accommodated in a slot. The total number of SEs accommodated in the network can be expressed as

$${\sum }_{s ∈ N}^{} {\sum }_{i ∈ {K}_{s}}^{} {y}_{s}^{i} .$$

Each SE can have different priorities in a given slot. The weighted number of SEs accommodated in the network can be expressed as

$${\sum }_{s ∈ N}^{} {\sum }_{i ∈ {K}_{s}}^{} {w}_{s}^{} {y}_{s}^{i}$$

that should be maximized.

The second objective accounts for CCE usage that should be minimized. The objective is composed of these two components. Using the scalar, θ, the objective is to maximize

$$θ {\sum }_{s ∈ N}^{} {\sum }_{i ∈ {K}_{s}}^{} {w}_{s}^{} {y}_{s}^{i} - ( 1 - θ ) {\sum }_{s ∈ N}^{} {\sum }_{i ∈ {K}_{s}}^{} {C}_{s}^{i} {y}_{s}^{i} .$$

According to E. Matskani, N. D. Sidiropoulos, Z. Q. Luo, and L. Tassiulas, “Convex approximation techniques for joint multiuser downlink beamforming and admission control,” IEEE Trans. Wireless Commun., vol. 7, no. 7, pp. 2682-2693 July 2008, any value of

$$θ ∈ ( \frac{{C}_{max}^{}}{1 + {C}_{max}^{}} , 1 ) ,$$

i.e., the optimal choice of the value, ensures maximizing the weighted number of users accommodated in the network.

The joint CCE and power allocation problem can be formulated in the following form:

$${max}_{y} θ {\sum }_{s ∈ N}^{} {\sum }_{i ∈ {K}_{s}}^{} {w}_{s}^{} {y}_{s}^{i} - ( 1 - θ ) {\sum }_{s ∈ N}^{} {\sum }_{i ∈ {K}_{s}}^{} {C}_{s}^{i} {y}_{s}^{i}$$

$$Subject to$$

$$\begin{matrix}( Constraint - 1 ) {\sum }_{s ∈ N}^{} {\sum }_{i ∈ {K}_{s}}^{} {P}_{s}^{i} {y}_{s}^{i} \leq {P}_{max}^{} , \\ ( Constraint - 2 ) {\sum }_{s ∈ N}^{} {\sum }_{i ∈ {K}_{s}}^{} {C}_{s}^{i} {y}_{s}^{i} \leq {C}_{max}^{} , \\ ( Constraint - 3 ) {\sum }_{i ∈ {K}_{s}}^{} {y}_{s}^{i} \leq 1 , for all s , \\ ( Constraint - 4 ) {\sum }_{i ∈ {K}_{s}}^{} \vert {P}_{s}^{i} - {P}_{CCE} {C}_{s}^{i} \vert {y}_{s}^{i} \leq {P}_{BoostingThr}^{} , for all s \\ ( Constraint - 5 ) {y}_{s}^{i} ∈ \{ 0 , 1 \} , for all s and i\end{matrix}$$

This formulation is an integer linear program, more particularly, a multiple knapsack problem. For solving such a problem optimally branch and bound type algorithms may be used. However, these algorithms have exponential complexity. Alternatively, it can be efficiently solved by using the approach in E. L. Lawler, “Fast approximation algorithms for knapsack problems,” Symposium on Foundations of Computer Science, 0:206-213, 1977, for example in a close-to-optimal way.

Particular embodiments use machine learning to solve the above problem. The optimization problem above may be solved for several instances of channel quality indicator (CQI) values (or estimated SINR values), DCI-sizes, total available power and total CCEs available. In this way, training data for online CCE and power allocation algorithm is generated.

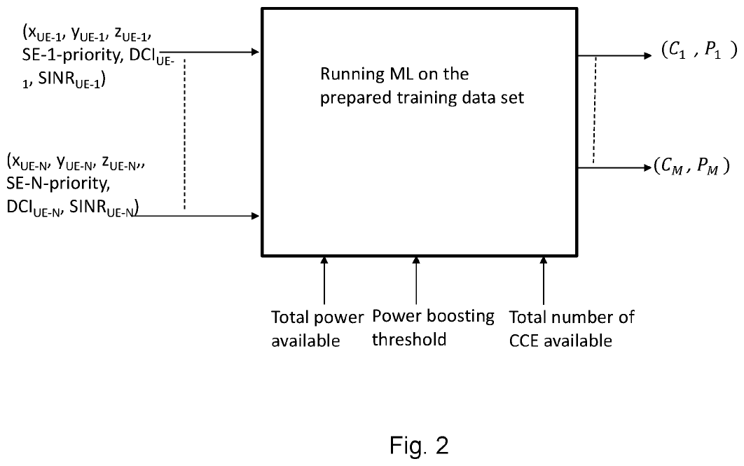

For example, a base station, such as a gNB, may use CQI values (or estimated SINR values), DCI-sizes, total available power and total CCEs available for all SEs as input and the trained CCE and power allocation model to select the best CCE-AL and power for each SE (such as a UE). An example is illustrated in FIG. 2.

FIG. 2 is a block diagram illustrating runtime input-output relation for online machine learning CCE assignment and power allocation. In the illustrated example, the network node runs the machine learning algorithm based on the prepared training data set. The machine learning algorithm receives input for each SE (e.g., SE-1 to SE-N). The input may include values for channel quality, DCI size, and/or priority for each SE. The machine learning algorithm also receives input regarding the total power available, the power boosting threshold, and/or the total number of CCEs available. Based on the inputs, the machine learning algorithm generates a CCE-AL and power for each SE. A network node may configure one or more SEs based on the generated CCE-AL and power values.

Some embodiments may perform real-time validation. For example, a base station may monitor the consecutive number of uplink/downlink hybrid automatic repeat request (HARQ) discontinuous transmissions (DTXs) and channel state information (CSI) DTXs. If an error threshold is reached, the machine learning model may be retrained.

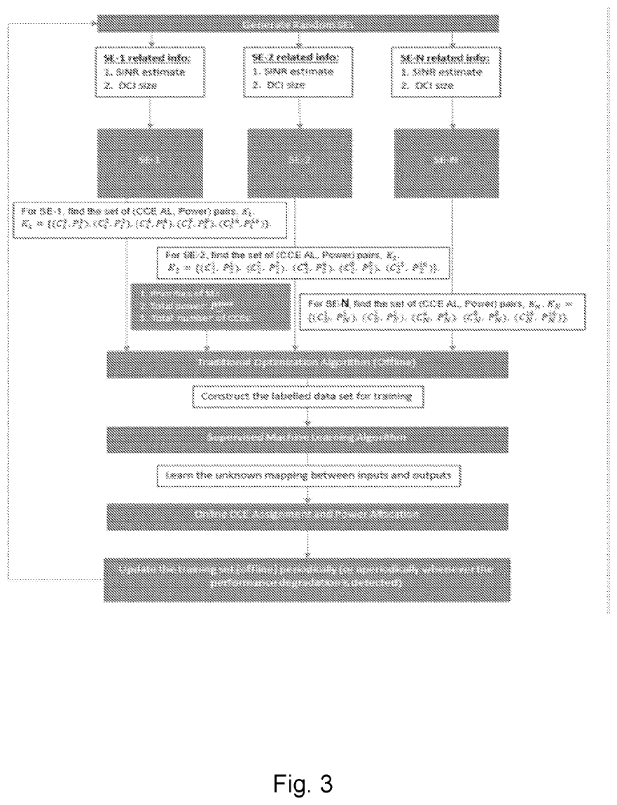

FIG. 3 is a flowchart illustrating the CCE assignment and power allocation algorithm, according to particular embodiments. The training step generates a random set of SEs (SE-to SE-N) along with their related information, such as SINR estimates and/or DCI sizes. For each SE, the training step finds the set of CCE-AL and power pairs and using the optimization algorithm offline, constructs the training data set. Using the training data set, the supervised machine learning algorithm learns the mapping between inputs and outputs. The mapping may be used online to determine CCE assignment and power allocation. The training set may be updated periodically, for example, if performance degradation is detected.

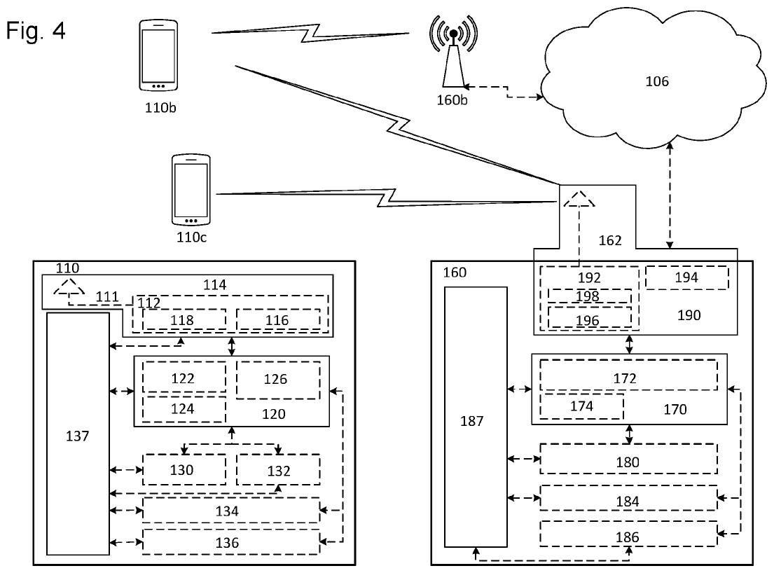

FIG. 4 illustrates an example wireless network, according to certain embodiments. The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and WD 110 comprise various components described in more detail below. These components work together to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network.

Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations.

A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs.

As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 4, network node 160 includes processing circuitry 170, device readable medium 180, interface 190, auxiliary equipment 184, power source 186, power circuitry 187, and antenna 162. Although network node 160 illustrated in the example wireless network of FIG. 4 may represent a device that includes the illustrated combination of hardware components, other embodiments may comprise network nodes with different combinations of components.

It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node.

In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality.

For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160 but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signaling and/or data between network node 160, network 106, and/or WDs 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162.

Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or WDs via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 192 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160.

For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 4 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air.

In some embodiments, a WD may be configured to transmit and/or receive information without direct human interaction. For instance, a WD may be designed to transmit information to a network on a predetermined schedule, when triggered by an internal or external event, or in response to requests from the network.

Examples of a WD include, but are not limited to, a smart phone, a mobile phone, a cell phone, a voice over IP (VOIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device.

As yet another specific example, in an Internet of Things (IoT) scenario, a WD may represent a machine or other device that performs monitoring and/or measurements and transmits the results of such monitoring and/or measurements to another WD and/or a network node. The WD may in this case be a machine-to-machine (M2M) device, which may in a 3GPP context be referred to as an MTC device. As one example, the WD may be a UE implementing the 3GPP narrow band internet of things (NB-IoT) standard. Examples of such machines or devices are sensors, metering devices such as power meters, industrial machinery, or home or personal appliances (e.g. refrigerators, televisions, etc.) personal wearables (e.g., watches, fitness trackers, etc.).

In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. WD 110 may include multiple sets of one or more of the illustrated components for different wireless technologies supported by WD 110, such as, for example, GSM, WCDMA, LTE, NR, WiFi, WiMAX, or Bluetooth wireless technologies, just to mention a few. These wireless technologies may be integrated into the same or different chips or set of chips as other components within WD 110.

Antenna 111 may include one or more antennas or antenna arrays, configured to send and/or receive wireless signals, and is connected to interface 114. In certain alternative embodiments, antenna 111 may be separate from WD 110 and be connectable to WD 110 through an interface or port. Antenna 111, interface 114, and/or processing circuitry 120 may be configured to perform any receiving or transmitting operations described herein as being performed by a WD. Any information, data and/or signals may be received from a network node and/or another WD. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 112 is connected to antenna 111 and processing circuitry 120 and is configured to condition signals communicated between antenna 111 and processing circuitry 120. Radio front end circuitry 112 may be coupled to or a part of antenna 111. In some embodiments, WD 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114.

Radio front end circuitry 112 may receive digital data that is to be sent out to other network nodes or WDs via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 110 components, such as device readable medium 130, WD 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of WD 110 may comprise a SOC. In some embodiments, RF transceiver circuitry 122, baseband processing circuitry 124, and application processing circuitry 126 may be on separate chips or sets of chips.

In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a WD may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner.

In any of those embodiments, whether executing instructions stored on a device readable storage medium or not, processing circuitry 120 can be configured to perform the described functionality. The benefits provided by such functionality are not limited to processing circuitry 120 alone or to other components of WD 110, but are enjoyed by WD 110, and/or by end users and the wireless network generally.

Processing circuitry 120 may be configured to perform any determining, calculating, or similar operations (e.g., certain obtaining operations) described herein as being performed by a WD. These operations, as performed by processing circuitry 120, may include processing information obtained by processing circuitry 120 by, for example, converting the obtained information into other information, comparing the obtained information or converted information to information stored by WD 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be integrated.

User interface equipment 132 may provide components that allow for a human user to interact with WD 110. Such interaction may be of many forms, such as visual, audial, tactile, etc. User interface equipment 132 may be operable to produce output to the user and to allow the user to provide input to WD 110. The type of interaction may vary depending on the type of user interface equipment 132 installed in WD 110. For example, if WD 110 is a smart phone, the interaction may be via a touch screen; if WD 110 is a smart meter, the interaction may be through a screen that provides usage (e.g., the number of gallons used) or a speaker that provides an audible alert (e.g., if smoke is detected).

User interface equipment 132 may include input interfaces, devices and circuits, and output interfaces, devices and circuits. User interface equipment 132 is configured to allow input of information into WD 110 and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from WD 110, and to allow processing circuitry 120 to output information from WD 110. User interface equipment 132 may include, for example, a speaker, a display, vibrating circuitry, a USB port, a headphone interface, or other output circuitry. Using one or more input and output interfaces, devices, and circuits, of user interface equipment 132, WD 110 may communicate with end users and/or the wireless network and allow them to benefit from the functionality described herein.

Auxiliary equipment 134 is operable to provide more specific functionality which may not be generally performed by WDs. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. WD 110 may further comprise power circuitry 137 for delivering power from power source 136 to the various parts of WD 110 which need power from power source 136 to carry out any functionality described or indicated herein. Power circuitry 137 may in certain embodiments comprise power management circuitry.

Power circuitry 137 may additionally or alternatively be operable to receive power from an external power source; in which case WD 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of WD 110 to which power is supplied.

Although the subject matter described herein may be implemented in any appropriate type of system using any suitable components, the embodiments disclosed herein are described in relation to a wireless network, such as the example wireless network illustrated in FIG. 4. For simplicity, the wireless network of FIG. 4 only depicts network 106, network nodes 160 and 160b, and WDs 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device (WD) 110 are depicted with additional detail. The wireless network may provide communication and other types of services to one or more wireless devices to facilitate the wireless devices' access to and/or use of the services provided by, or via, the wireless network.

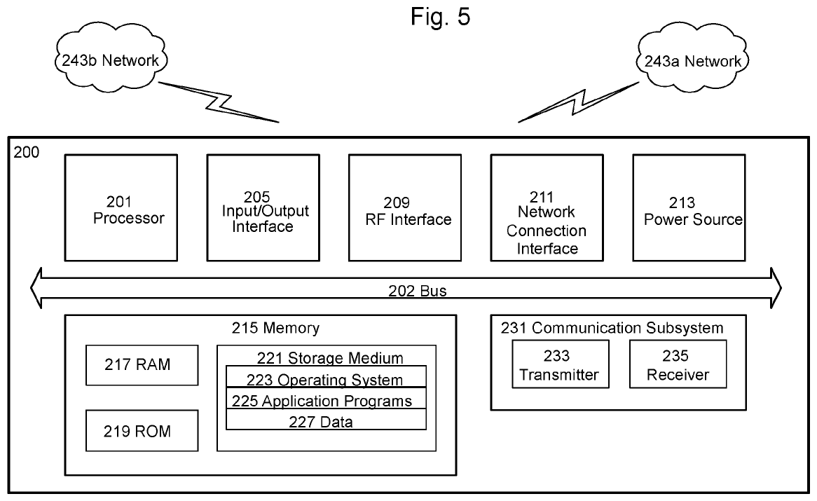

FIG. 5 illustrates an example user equipment, according to certain embodiments. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 200 may be any UE identified by the 3^{rd} Generation Partnership Project (3GPP), including a NB-IoT UE, a machine type communication (MTC) UE, and/or an enhanced MTC (eMTC) UE. UE 200, as illustrated in FIG. 5, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 5 is a UE, the components discussed herein are equally applicable to a WD, and vice-versa.

In FIG. 5, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 213, and/or any other component, or any combination thereof. Storage medium 221 includes operating system 223, application program 225, and data 227. In other embodiments, storage medium 221 may include other similar types of information. Certain UEs may use all the components shown in FIG. 5, or only a subset of the components. The level of integration between the components may vary from one UE to another UE. Further, certain UEs may contain multiple instances of a component, such as multiple processors, memories, transceivers, transmitters, receivers, etc.

In FIG. 5, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205.

An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof.

UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 5, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory.

Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 5, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another WD, UE, or base station of a radio access network (RAN) according to one or more communication protocols, such as IEEE 802.2, CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

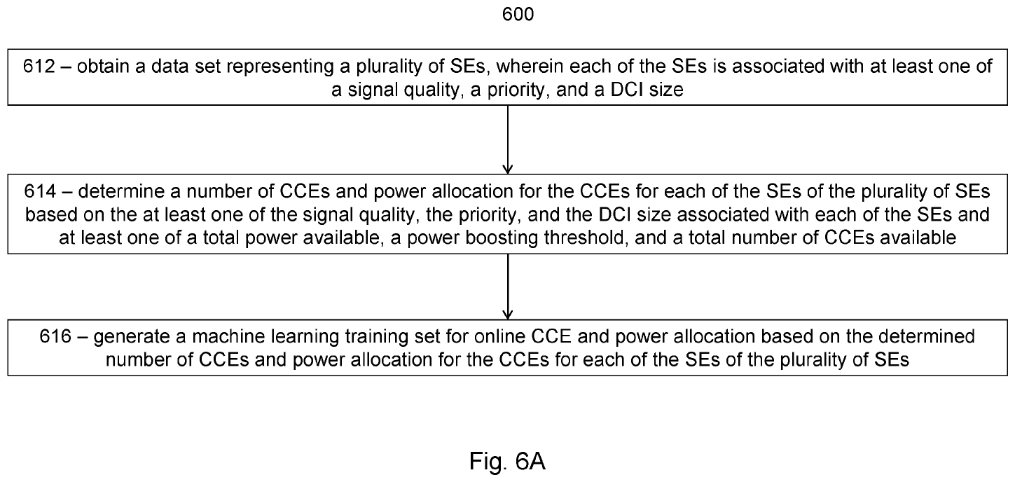

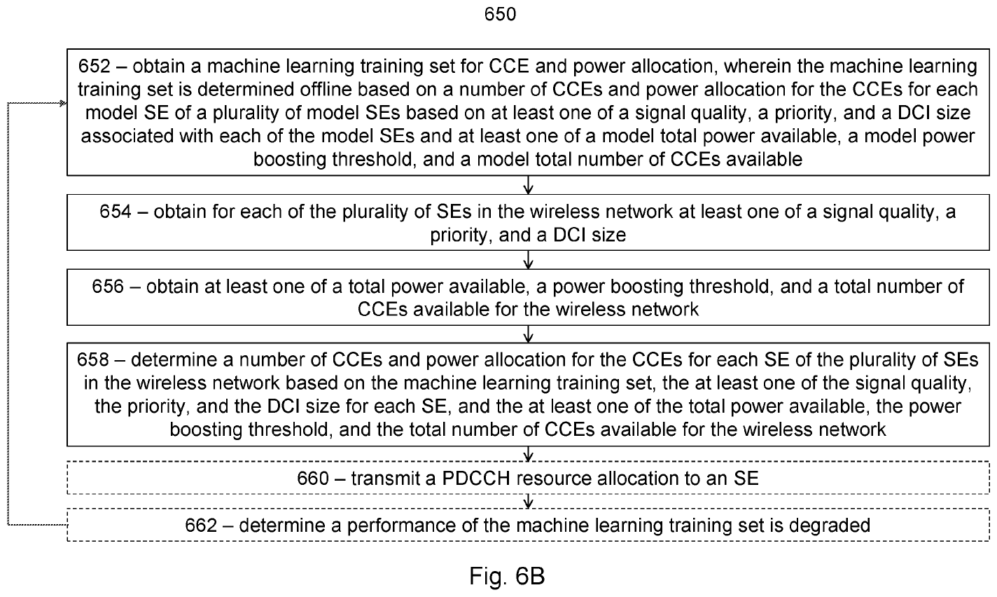

FIG. 6A is a flowchart illustrating an example method in a network node, according to certain embodiments. In particular embodiments, one or more steps of FIG. 6A may be performed by network node 160 described with respect to FIG. 4. In some embodiments, one or more steps of FIG. 6A may be performed by another network node, such as a core network node or any suitable server or processor. In general, method 600 comprises solving an optimization problem offline to generate a machine learning training set.

The method begins at step 612, where the network node (e.g., network node 160) obtains a data set representing a plurality of scheduling entities (SEs) wherein each of the SEs is associated with at least one of a signal quality, a priority, and a downlink control information (DCI) size.

For example, the network node may generate combinations of signal qualities (e.g., SINR, CQI, etc.), priorities, and DCI-sizes for a plurality of SEs to simulate any number of network conditions. In some embodiments, the network node may receive the generated combinations from another network node or be configured via user input. The network node may obtain the data set according to any of the embodiments and examples described herein.

At step 614, the network node determines a number of control channel elements (CCEs) and power allocation for the CCEs for each of the SEs of the plurality of SEs based on the at least one of the signal quality, the priority, and the DCI size associated with each of the SEs and at least one of a total power available, a power boosting threshold, and a total number of CCEs available.

For example, the wireless device may solve the optimization problem based on the obtained data set and a combination of network values for total power available, a power boosting threshold, and a total number of CCEs available. The network node may determine the number of CCEs and power allocation for the CCEs according to any of the embodiments and examples described herein.

In particular embodiments, determining the number of CCEs and power allocation for the CCEs for each of the SEs of the plurality of SEs is based on a plurality of signal quality, priority, and DCI size combinations associated with each of the SEs. Determining the number of CCEs and power allocation for the CCEs for each of the SEs of the plurality of SEs may be based on whether each SE uses a common search space or a user specific search space. Determining the number of CCEs and power allocation for the CCEs for each of the SEs of the plurality of SEs may be based on a plurality of total power available, power boosting threshold, and total number of CCEs combinations. Determining the number of CCEs and power allocation for the CCEs for each of the SEs of the plurality of SEs may comprise determining a number of CCEs and power allocation for the CCEs for each aggregation level of a plurality of CCE aggregation levels. Determining the number of CCEs and power allocation for the CCEs for each of the SEs of the plurality of SEs may comprise determining a number of CCEs and power allocation for the CCEs for each of the SEs of the plurality of SEs to maximize a number of SEs per slot and minimize total CCE consumption.

At step 616, the network node generates a machine learning training set for online CCE and power allocation based on the determined number of CCEs and power allocation for the CCEs for each of the SEs of the plurality of SEs. The network node generate the machine learning training set according to any of the embodiments and examples described herein.

Modifications, additions, or omissions may be made to method 600 of FIG. 6A. Additionally, one or more steps in the method of FIG. 6A may be performed in parallel or in any suitable order.

FIG. 6B is a flowchart illustrating another example method in a network node, according to certain embodiments. In particular embodiments, one or more steps of FIG. 6B may be performed by network node 160 described with respect to FIG. 4. In general, the method may use the machine learning training set generated in method 600 to perform online PDCCH resource allocation for a plurality of SEs in a wireless network.

The method begins at step 652, where the network node (e.g., network node 160) obtains a machine learning training set for CCE and power allocation, wherein the machine learning training set is determined offline based on a number of CCEs and power allocation for the CCEs for each model SE of a plurality of model SEs based on at least one of a signal quality, a priority, and a DCI size associated with each of the model SEs and at least one of a model total power available, a model power boosting threshold, and a model total number of CCEs available. For example, the network node may obtain the machine learning training set generated in method 600.

At step 654, the network node obtains, for each of the plurality of SEs in the wireless network, at least one of a signal quality, a priority, and a DCI size. For example, the network node may obtain (e.g., through measurements, configurations, etc.) values for signal quality, a priority, and/or a DCI size for the SEs in the network.

At step 656, the network node obtains at least one of a total power available, a power boosting threshold, and a total number of CCEs available for the wireless network. For example, the network node may obtain the information via configuration or may autonomously determine the values (or any combination).

At step 658, the network node determines a number of CCEs and power allocation for the CCEs for each SE of the plurality of SEs in the wireless network based on the machine learning training set, the at least one of the signal quality, the priority, and the DCI size for each SE, and the at least one of the total power available, the power boosting threshold, and the total number of CCEs available for the wireless network. For example, based on the machine learning training set and the actual values obtained from the network, the network node can determine the number of CCEs and power allocation for each SE.

The network node may determine the number of CCEs and power allocation for the CCEs for each SE of the plurality of SEs in the wireless network according to any of the embodiments and examples described herein.

In particular embodiments, determining the number of CCEs and power allocation for the CCEs for each of the SEs of the plurality of SEs is based on whether each SE uses a common search space or a user specific search space. Determining the number of CCEs and power allocation for the CCEs for each of the SEs of the plurality of SEs may comprise determining a number of CCEs and power allocation for the CCEs for each of the SEs of the plurality of SEs to maximize a number of SEs per slot and minimize total CCE consumption.

At step 660, the network node transmits a PDCCH resource allocation to an SE of the plurality of the SEs in the wireless network based on the determined number of CCEs and power allocation for the CCEs for each SE of the plurality of SEs in the wireless network. For example, the network node uses the determined values to configures the SEs.

Over time, the machine learning training model may become outdated. At step 662, the network node determines a performance of the machine learning training set is degraded. For example, the network node may determine the performance of the machine learning training set is degraded based on at least one of a number of hybrid automatic repeat request (HARQ) discontinuous transmissions and a number of channel state information (CSI) discontinuous transmissions. Upon determining the machine learning training set is degraded, the method may return to step 652, where the network node obtains an updated machine learning training set.

Modifications, additions, or omissions may be made to method 650 of FIG. 6B. Additionally, one or more steps in the method of FIG. 6B may be performed in parallel or in any suitable order.

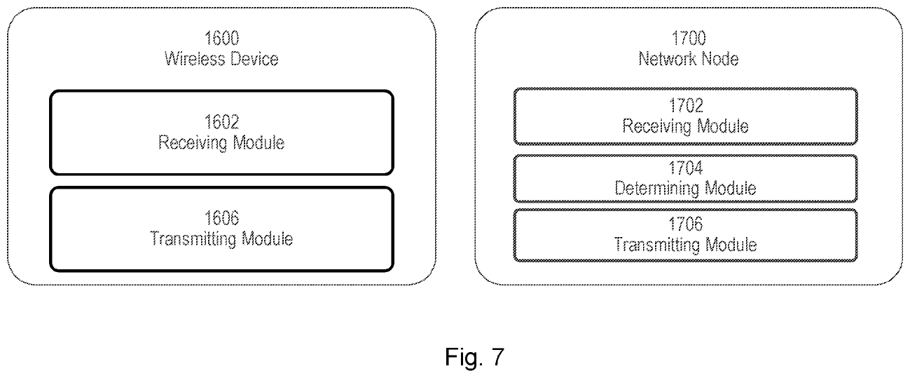

FIG. 7 illustrates a schematic block diagram of two apparatuses in a wireless network (for example, the wireless network illustrated in FIG. 4). The apparatuses include a wireless device and a network node (e.g., wireless device 110 and network node 160 illustrated in FIG. 4). Apparatus 1700 is operable to carry out the example methods described with reference to FIGS. 6A and 6B, and possibly any other processes or methods disclosed herein. It is also to be understood that the methods of FIGS. 6A and 6B are not necessarily carried out solely by apparatus 1700. At least some operations of the methods can be performed by one or more other entities.

Virtual apparatuses 1600 and 1700 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments.

In some implementations, the processing circuitry may be used to cause receiving module 1602, transmitting module 1606, and any other suitable units of apparatus 1600 to perform corresponding functions according one or more embodiments of the present disclosure. Similarly, the processing circuitry described above may be used to cause receiving module 1702, determining module 1704, transmitting module 1706, and any other suitable units of apparatus 1700 to perform corresponding functions according one or more embodiments of the present disclosure.

As illustrated in FIG. 5, apparatus 1600 includes receiving module 1602 configured to receive configuration information according to any of the embodiments and examples described herein. Transmitting module 1606 is configured to transmit a signals according to any of the embodiments and examples described herein.

As illustrated in FIG. 5, apparatus 1700 includes receiving module 1602 configured to perform the obtaining functions described herein. Determining module 1704 is configured to determine a number of CCEs and power allocation for the CCEs according to any of the embodiments and examples described herein. Transmitting module 1706 is configured to transmit configuration information according to any of the embodiments and examples described herein.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Modifications, additions, or omissions may be made to the systems and apparatuses disclosed herein without departing from the scope of the invention. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods disclosed herein without departing from the scope of the invention. The methods may include more, fewer, or other steps. Additionally, steps may be performed in any suitable order.

The foregoing description sets forth numerous specific details. It is understood, however, that embodiments may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the claims below.

1. A method performed by a network node for generating a machine learning training set for physical downlink control channel (PDCCH) resource allocation, the method comprising:
obtaining a data set representing a plurality of scheduling entities (SEs), each of the SEs being associated with at least one of a signal quality, a priority, and a downlink control information (DCI) size;
determining a number of control channel elements (CCEs) and power allocation for the CCEs for each of the SEs of the plurality of SEs based on the at least one of the priority, and the DCI size associated with each of the SEs and at least one of a total power available, a power boosting threshold, and a total number of CCEs available, determining the number of CCEs and power allocation for the CCEs for each of the SEs of the plurality of SEs being further based on whether each SE uses a common search space or a user specific search space; and
generating a machine learning training set for online CCE and power allocation based on the determined number of CCEs and power allocation for the CCEs for each of the SEs of the plurality of SEs.

2. The method of claim 1, wherein determining the number of CCEs and power allocation for the CCEs for each of the SEs of the plurality of SEs is further based on a plurality of signal quality, priority, and DCI size combinations associated with each of the SEs.

3. (canceled)

4. The method of claim 1, wherein determining the number of CCEs and power allocation for the CCEs for each of the SEs of the plurality of SEs is further based on a plurality of total power available, power boosting threshold, and total number of CCEs combinations.

5. The method of claim 1, wherein determining the number of CCEs and power allocation for the CCEs for each of the SEs of the plurality of SEs comprises determining a number of CCEs and power allocation for the CCEs for each aggregation level of a plurality of CCE aggregation levels.

6. The method of claim 1, wherein determining the number of CCEs and power allocation for the CCEs for each of the SEs of the plurality of SEs comprises determining a number of CCEs and power allocation for the CCEs for each of the SEs of the plurality of SEs to maximize a number of SEs per slot and minimize total CCE consumption.

7. The method of claim 1, wherein the signal quality associated with each of the SEs is based on at least one of a signal to interference and noise ratio (SINR), a channel quality indicator (CQI) and a geographical position of the SE.

8. A network node capable of physical downlink control channel (PDCCH) resource allocation, the network node comprising processing circuitry (170) operable to:
obtain a data set representing a plurality of scheduling entities (SEs), wherein each of the SEs is associated with at least one of a signal quality, a priority, and a downlink control information (DCI) size;
determine a number of control channel elements (CCEs) and power allocation for the CCEs for each of the SEs of the plurality of SEs based on the at least one of the priority, and the DCI size associated with each of the SEs and at least one of a total power available, a power boosting threshold, and a total number of CCEs available, determining the number of CCEs and power allocation for the CCEs for each of the SEs of the plurality of SEs being further based on whether each SE uses a common search space or a user specific search space; and
generate a machine learning training set for online CCE and power allocation based on the determined number of CCEs and power allocation for the CCEs for each of the SEs of the plurality of SEs.

9. The network node of claim 8, wherein the processing circuitry is operable to determine the number of CCEs and power allocation for the CCEs for each of the SEs of the plurality of SEs further based on a plurality of signal quality, priority, and DCI size combinations associated with each of the SEs.

10. (canceled)

11. The network node of claim 8, wherein the processing circuitry is operable to determine the number of CCEs and power allocation for the CCEs for each of the SEs of the plurality of SEs further based on a plurality of total power available, power boosting threshold, and total number of CCEs combinations.

12. The network node of claim 8, wherein the processing circuitry is operable to determine the number of CCEs and power allocation for the CCEs for each of the SEs of the plurality of SEs by determining a number of CCEs and power allocation for the CCEs for each aggregation level of a plurality of CCE aggregation levels.

13. The network node of claim 8, wherein the processing circuitry is operable to determine the number of CCEs and power allocation for the CCEs for each of the SEs of the plurality of SEs by determining a number of CCEs and power allocation for the CCEs for each of the SEs of the plurality of SEs to maximize a number of SEs per slot and minimize total CCE consumption.

14. The network node of claim 8, wherein the signal quality associated with each of the SEs is based on at least one of a signal to interference and noise ratio (SINR), a channel quality indicator (CQI) and a geographical position of the SE.

15. A method performed by a network node for physical downlink control channel (PDCCH) resource allocation for a plurality of scheduling entities (SEs) in a wireless network, the method comprising:
obtaining a machine learning training set for control channel element (CCE) and power allocation, wherein the machine learning training set is determined offline based on a number of CCEs and power allocation for the CCEs for each model SE of a plurality of model SEs based on at least one of a priority, and a DCI size associated with each of the model SEs and at least one of a model total power available, a model power boosting threshold, and a model total number of CCEs available;
training the machine learning training set in a machine learning algorithm;
obtaining for each of the plurality of SEs in the wireless network at least one of a priority, and a DCI size;
obtaining at least one of a total power available, a power boosting threshold, and a total number of CCEs available for the wireless network; and
determining a number of CCEs and power allocation for the CCEs for each SE of the plurality of SEs in the wireless network based on the machine learning training set trained by the machine learning algorithm, the at least one of the priority, and the DCI size for each SE, and the at least one of the total power available, the power boosting threshold, and the total number of CCEs available for the wireless network, determining the number of CCEs and power allocation for the CCEs for each of the SEs of the plurality of SEs being further based on whether each SE uses a common search space or a user specific search space.

16. The method of claim 15, further comprising transmitting a PDCCH resource allocation to an SE of the plurality of the SEs in the wireless network based on the determined number of CCEs and power allocation for the CCEs for each SE of the plurality of SEs in the wireless network.

17.-21. (canceled)

22. A network node capable of physical downlink control channel (PDCCH) resource allocation for a plurality of scheduling entities (SEs) in a wireless network, the network node comprising processing circuitry operable to:
obtain a machine learning training set for control channel element (CCE) and power allocation, wherein the machine learning training set is determined offline based on a number of CCEs and power allocation for the CCEs for each model SE of a plurality of model SEs based on at least one of a priority, and a DCI size associated with each of the model SEs and at least one of a model total power available, a model power boosting threshold, and a model total number of CCEs available;
train the machine learning training set in a machine learning algorithm;
obtain for each of the plurality of SEs in the wireless network at least one of a priority, and a DCI size;
obtain at least one of a total power available, a power boosting threshold, and a total number of CCEs available for the wireless network; and
determine a number of CCEs and power allocation for the CCEs for each SE of the plurality of SEs in the wireless network based on the machine learning training set trained by the machine learning algorithm, the at least one of the priority, and the DCI size for each SE, and the at least one of the total power available, the power boosting threshold, and the total number of CCEs available for the wireless network, determining the number of CCEs and power allocation for the CCEs for each of the SEs of the plurality of SEs being further based on whether each SE uses a common search space or a user specific search space.

23.-28. (canceled)
